(19) United States
(12) Patent Application Publication
(10) Pub. No.: US 2016/0138729 A1
(43) Pub. Date: May 19, 2016

(54) A MECHANISM FOR EFFECTING A DISPLACEMENT OUTPUT

(71) Applicants: Mohamed Sirajudeen Mohamed ISMAIL, Singapore (SG); Hilaal ALAM, Singapore (SG)

(72) Inventors: Mohamed Sirajudeen Mohamed ISMAIL, Singapore (SG); Hilaal ALAM, Singapore (SG)

(21) Appl. No.: 14/892,936

(22) PCT Filed: May 22, 2013
(86) PCT No.: PCT/SG2013/000211

§ 371 Date: Nov. 20, 2015

(51) Int. Cl. F16K 31/44; F01L 9/02; F01L 9/04

(52) U.S. Cl. CPC F16K 31/44; F01L 9/04; F01L 9/02; F01L 2009/0413

(57) ABSTRACT

A mechanism for effecting a displacement output, the mechanism comprising: at least one flexural module, the at least one flexural module comprising: a frame; at least one component connected to the frame via a first flexure and connected to the displacement output via at least a second flexure; wherein the at least one flexural module is monolithic and/or unitary and each component is configured to be independently actuatable such that the displacement output is displaced when at least one component is actuated.

### FIELD

The invention relates to a mechanism for effecting a displacement output, and in particular, but not limited to, such a mechanism for use in a system for controlling a valve in an internal combustion engine.

### BACKGROUND

In internal combustion engines, control of fuel flow is administered by changing a cross section area perpendicular to the flow direction or volume of a typically tubular flow path by means of valves. Traditionally, an engine cam that controls valve opening timings and opening sizes is rotated by a power transmission chain connected to an engine crank shaft. The rise and fall of cam movement causes each valve to open and close continuously, synchronizing with engine or piston movement. FIG. 1 (prior art) depicts a typical overhead cam valve assembly.

However, wear and tear on the cam profile causes variation of reduction in rise and fall of the cam. This variation affects the valve opening and closure and hence fuel flow. This in turn affects the performance of the engine due to improper fuel intake and incomplete combustion due to loss of precision in the valve opening timing and sizes. Furthermore, in the traditional cam-based valve operation, flow of fuel depends on cam displacement only, and it is nearly impossible to control the flow of fuel with valve movements after the cam-based valve control has been mounted on the engine.

### SUMMARY

In general terms the invention proposes a flexure-based mechanism for effecting displacement. Used in an internal combustion engine, the mechanism may provide improved directional displacement over conventional cam-based valve control, thereby improving fuel efficiency. The mechanism may comprise flexure connections and may be used for opening, closure and control of intake or exhaust path of internal combustion engines, since the flexures which operate based on a deformation mechanism provide directional control and displacement control for valve displacement.

Solid state actuators such as PZT, PMN, electro-strictive/magneto-strictive actuators or conventional actuators may be used for actuation of the mechanism. The mechanism is particularly suited for use in automobile, fluid and hydraulic systems, oil & gas systems, ship/navel systems, aerospace applications and space applications. Embodiments may provide a flexural system for controlling valve operation with displacement/force amplification or reduction. It may be used for precise control of flow at an engine fuel intake, or precise control of opening and closure time of a valve for possible optimal or maximum combustion of fuel, thereby providing a camless solution for valve operations.

It may be possible to control or operate valves independently of the prime movers such as the engine, and to control each valve independently of other valves. Helical springs in traditional cam-based valve control may be replaced with flexures. This may reduce space required for valve operation and achieves controlled movement of the valve with extremely high setting time, while at high to moderate setting time, accelerated movement of the valve may also be achieved. Force amplification in addition to displacement amplification may also be achieved together with the use of reinforcement flexures to avoid back-buckling. This may be accomplished by using individual actuators to independently actuate flexural modules configured for force amplification, displacement amplification and reinforcement. Simultaneous same-direction or opposite-direction opening or closure of multiple valves with a single-point actuation may also be achieved.

In a first specific expression of the invention there is provided a mechanism according to claim 1.

In a second specific expression of the invention there is provided a system according to claim 15.

Embodiments may be implemented according to any of claim 2-14 or 16-17.

### BRIEF DESCRIPTION OF FIGURES

In order that the invention may be fully understood and readily put into practical effect there shall now be described by way of non-limitative example only exemplary embodiments of the present invention, the description being with reference to the accompanying illustrative drawings in which:

FIG. 1 (prior art) is a schematic illustration of a conventional cam-driven valve in an internal combustion engine;

FIG. 2 is a schematic illustration of an exemplary flexural module of a mechanism for effecting a displacement output;

FIG. 3 is a schematic illustration of an exemplary displacement flexural module;

FIG. 4a is a schematic illustration of an exemplary displacement flexural module configured to actuate two output components simultaneously in a same direction;

FIG. 4b is a schematic illustration of an exemplary displacement flexural module configured to actuate two output components simultaneously in opposite directions;

FIG. 5 is a schematic illustration of an exemplary force flexural module;

FIG. 6 is a schematic illustration of an exemplary mechanism for effecting a displacement output comprising a displacement flexural module, a force flexural module, a reinforcement flexural module and an alignment flexural module;

FIG. 7 is a schematic illustration of parasitic deflection when an alignment flexural module is displaced;

FIG. 8 is a schematic illustration of a system for controlling a valve;

FIG. 9 is a schematic illustration of a uniform cross-section leaf spring flexure;

FIG. 10 is a schematic illustration of a non-uniform cross-section leaf spring flexure;

FIG. 11 is a schematic illustration of a circular single axis flexure;

FIG. 12 is a schematic illustration of a non-circular single (i.e. elliptical) flexure;

FIG. 13 is a schematic illustration of a circular single notch flexure;

FIG. 14 is a schematic illustration of a non-circular single notch (i.e. elliptical) flexure;

FIG. 15 is a schematic illustration of an assymetrical flexure; and

FIG. 16 is a schematic illustration of an operational embodiment of the mechanism of FIG. 6.

### DETAILED DESCRIPTION

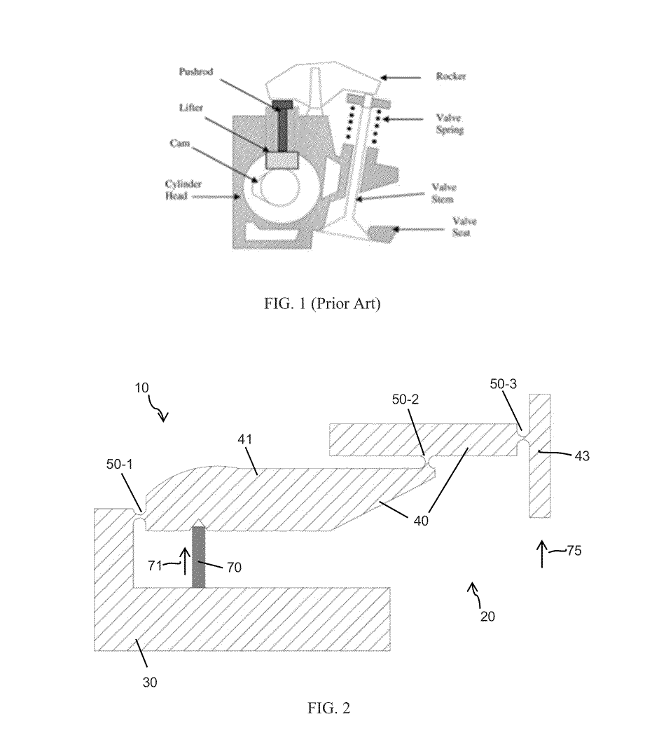

Exemplary embodiments of a mechanism for effecting a displacement output will be described with reference to FIGS. 2 to 16 below.

In its simplest form, as shown in FIG. 2, the mechanism 10 comprises at least one flexural module 20. Each flexural module 20 comprises a frame 30. The frame 30 may be configured to be mounted to another structure, or the frame 30 may be connected to another flexural module 20 where desired. The flexural module 20 also comprises at least one component 40 connected to the frame via a first flexure 51, and connected to an output component 43 via at least a second flexure 50-2, 50-3. The flexural module 20 is integrally formed and independently actuatable such that the output component 43 is displaced when the flexural module 20 is actuated. By integrally formed, it is meant that the flexural module 20 has no disengagable parts but is of a monolithic structure. For example, the flexural module 20 may be machined from a single block of material, or the parts may be welded together, or the flexural module 20 may be integrally moulded and so on. In this way, the flexural module 20 will not suffer from loosening or wear of any joints that can result in varying or inaccurate displacement of the output component 243.

Preferably, one 41 of the at least one component 40 is configured to receive actuation by an actuator 70 in order to actuate the at least one flexural module 20. The at least one flexural module 20 is independently actuatable using the actuator 70 such that actuation of the at least one flexural module 20 in the direction shown by arrow 71 displaces the output component 43. In the configuration shown, the output component 43 is displaced in the direction shown by arrow 75. Depending on the application in which the flexural module 20 is used, displacement of the output component 43 may lead to opening or closing of a valve, for example, if the flexural module 20 is used to actuate a valve in an internal combustion engine.

The actuator 70 used may be a solid state actuator such as PZT, PMN etc., which is operated through a precision power amplifier that can change the frequency of actuation as required. In place of solid state actuators, any kind of actuators like electromechanical systems or hydraulic actuators may be used. For example, the actuator 70 may be any one of an electro-mechanical, electro-magnetic, hydraulic, mechanical, thermal, thermoelectric, opto-thermal, or electro-thermal actuator. The actuator 70 is appropriately preloaded if necessary and is assembled into the flexural module 20 without any significant play. The actuator 70 is preferably controlled by electronics in a computer controlled system in such a way that the components 40 may oscillate or displace the output component 43 at different speeds. The frequency of oscillation should always be below the resonant frequency of the flexural module 20 or the actuator 70, whichever is lower.

When the mechanism 10 is used in an internal combustion engine, the actuator 70 is controlled by the electronics preferably so as to halt for a few micro/milliseconds for a sufficient fuel supply at an intake valve as well as for the adequate combustion before outlet valve opening. The electronics system is preferably integrated with sensors, for example proximity sensors, for precise operation regarding the fuel supply and the amount of combustion. Besides proximity sensors, other sensors such as thermal, optical, electric charge (capacitance), mechanical load, electric resistive, electric current, fluid flow and/or sonic sensors may be used where appropriate.

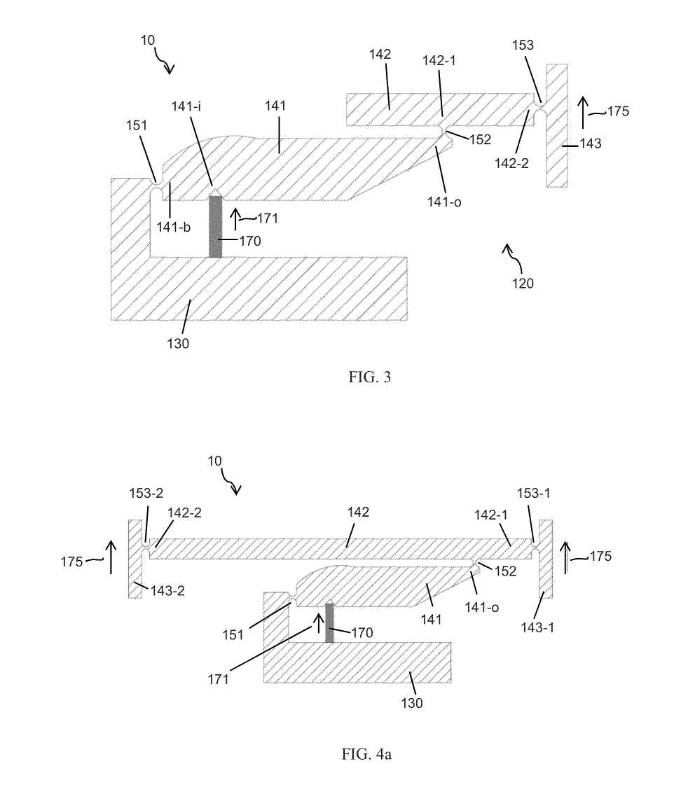

In one example, as shown in FIG. 3, the flexural module 20 may comprise a displacement flexural module 120 configured to amplify displacement provided by a displacement actuator 170. The displacement flexural module 120 comprises a displacement component 141 that is configured to receive actuation by a displacement actuator 170 in order to actuate the displacement flexural module 120. Accordingly, the displacement component 141 preferably has a bearing portion 141-b connected to the frame 130 of the displacement flexural module 120 via a flexure 151, an input portion 141-i configured to receive actuation by the displacement actuator 170, and an output portion 141-o configured to be connected to the output component 143.

In order for the displacement flexural module 120 to provide displacement amplification, distance between the output portion 141-o and the bearing portion 141-b of the displacement component 141 is greater than the distance between the input portion 141-i and the bearing portion 141-b of the displacement component 141.

In one configuration, the displacement flexural module 120 may comprise a frame 130, three components 141, 142, 143 and three flexures 151, 152, 153. The frame 130, the three components 141, 142, 143 and a valve (not shown) are interconnected via the three flexures 151, 152, 153 respectively. In this exemplary configuration, the second component 142 is provided to connect the displacement component 141 with the output component 143. A second flexure 152 is provided to connect the output portion 141-o of the displacement component 141 with a first portion 142-1 of the second component 142, while a second portion 142-2 of the second component 142 is connected via a third flexure 153 to the output component 143 that displaces in the direction shown by arrow 175 when the actuator 170 actuates in the direction shown by arrow 171.

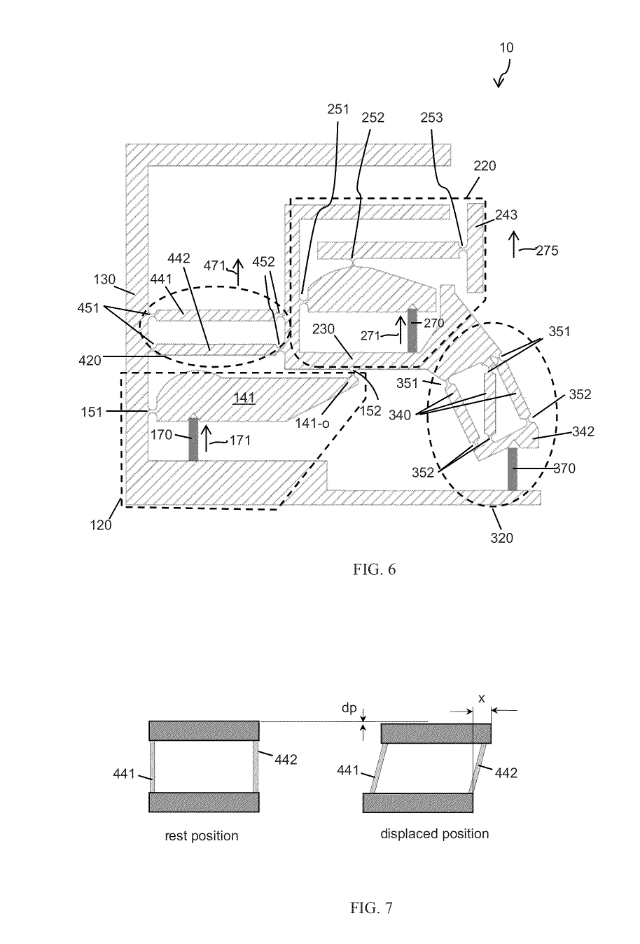

Alternatively, the displacement flexural module 120 may have only one component 141 that is connected to the output component 243 via a further flexural module 220 provided in the mechanism 10, as will be described below with reference to FIGS. 6 and 15.

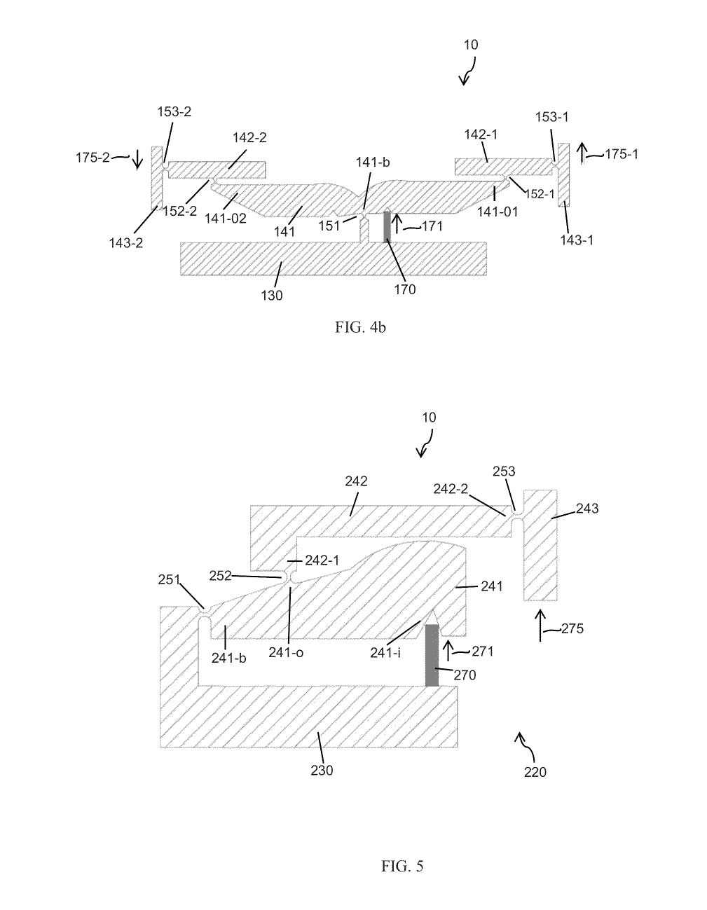

In one embodiment, one displacement flexural module 120 may be provided to activate two output components 143-1, 143-2 in an identical operation, that is, the two output components 143-1, 143-2 are displaced in a same direction as shown by arrows 175, as shown in FIG. 4a. In this embodiment, the output portion 141-o of the displacement component 141 is configured to be connected to a second output component 143-2 as well as a first output component 143-1. To achieve that, in one configuration, the output portion 141-o of the displacement component 141 may be connected to a second component 142. The second component 142 has two ends 142-1, 142-2, each end 142-1, 142-2 connected to the output components 143-1, 143-2 respectively via a flexure 153-1, 153-2 respectively such that each output component 143-1, 143-2 displaces when the actuator actuates in the direction shown by arrow 171.

In another embodiment, one displacement flexural module 120 may be provided to activate two output components 143-1, 143-2 in a non-identical operation, that is, the two output components 143-1, 143-2 are displaced in opposite directions as shown by arrows 175-1 and 175-2, as shown in FIG. 4b, when the actuator is actuated in the direction shown by arrow 171. In this embodiment, the displacement component 141 comprises a first output portion 141-o1 configured to be connected to the first output component 143-1 and a second output portion 141-o2 configured to be connected to the second output component 143-1. To achieve the simultaneous and opposite displacement of the first and second output components 143-1, 143-2, the first output portion 141-o1 is provided on one side of the bearing portion 141-b that is connected to the frame 130, while the second output portion 141-o2 is provided on an another side of the bearing portion 141-b. In an exemplary configuration, two second components 142-1, 142-2 are respectively connected to the two output portions 141-o1, 141-o2, and two output components 143-1, 143-2 that displace in opposite directions respectively are connected respectively to the two second components 142-1, 142-2 via flexures 153-1, 153-2 respectively. Alternatively, the two output portions 141-o1, 141-o2 may be connected to further modules 20 provided in the mechanism 10.

Alternatively, as shown in FIG. 5, the flexural module 20 may comprises a force flexural module 220 configured to amplify force provided by a force actuator 270. The force flexural module 220 preferably comprises a force component 241 having a bearing portion 241-b connected to the frame 230 of the force flexural module 220 via a flexure 251, an input portion 241-i configured receive actuation by the force actuator 270, and an output portion 241-o configured to be connected to the valve.

In order for the force flexural module 220 to amplify force provided by the force actuator 270, distance between the input portion 241-i and the bearing portion 241-b is greater than the distance between the output portion 241-o and the bearing portion 241-b.

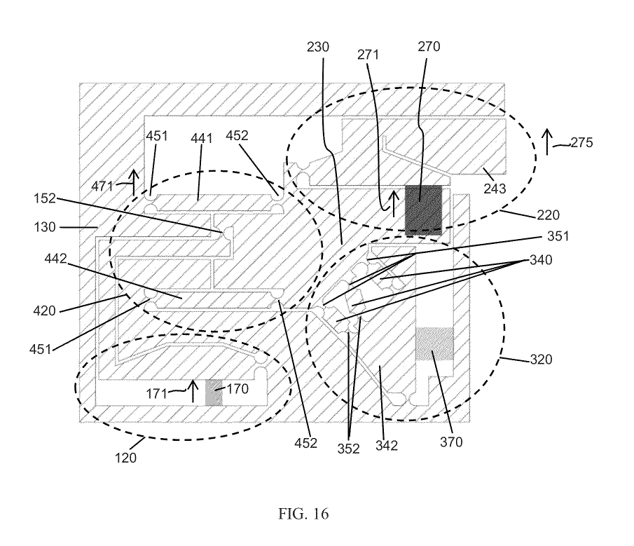

In an exemplary configuration, the force flexural module 220 may comprise a frame 230, two components 241, 242, 243 and three flexures 251, 252, 253. The frame 230, the three components 241, 242, 243 and a valve (not shown) are interconnected via the three flexures 251, 252, 253 respectively. In this exemplary configuration, the first flexure 251 connects the force component 241 with the frame 230. The second component 242 is provided to connect the force component 241 with the output component 243. The second flexure 252 connects the output portion 241-o of the force component 241 with a first portion 242-1 of the second component 242, while a second portion 242-2 of the second component 242 is connected via the third flexure 253 to the output component 243 that displaces when the actuator 270 actuates in the direction shown by arrow 271. In this configuration, the output component 243 displaces in the direction shown by arrow 275.

Where the mechanism 10 comprises two flexural modules 20 such as the displacement flexural module 120 and the force flexural module 220 described above, an alignment flexural module 420 as shown in FIG. 6 may be provided and configured to connect the first flexural module 120 with the second flexural module 220 via flexures 451, 452 such that actuation of the first flexural module 120 results in non-rotational movement of the second flexural module 220. FIG. 16 shows an envisaged operational embodiment of the mechanism 10 of FIG. 6. The same reference numerals have been used for corresponding parts in FIGS. 6 and 16.

Preferably, the alignment flexural module 420 comprises two alignment components 441, 442 having a same length and arranged in parallel. First ends of the two alignment components 441, 442 are preferably connected via flexures 451 to the frame 130 of the first flexural module 120 while second ends of the two alignment components 441, 442 are similarly preferably connected via flexures 452 to the frame 230 of the second flexural module 220.

In the configuration of FIG. 6, in addition to the displacement amplification provided by the displacement flexural module 120, force amplification by the force flexural module 220 may be performed when needed at the resultant end of the alignment flexural module 420.

As shown in FIG. 7, when the alignment flexural module 420 moves from a rest position to a displaced position, there is a slight parasitic deflection (dp) perpendicular to the flexural movement. To compensate for the parasitic deflection (dp) which is approximately about 5-10% of the displacement (x), the reinforcement actuator 370 may be activated. The parasitic deflection is given by equation (1) below:

dp˜x²/2l (1)

where x is the displacement and l is the length of the alignment components 441, 442.

In the mechanism 10 shown in FIGS. 6 and 16, actuation of the displacement flexural module 120 results in a parasitic deflection (dp) of the alignment flexural module 420 in the direction shown by arrow 471.

Preferably, the mechanism 10 additionally comprises a reinforcement flexural module 320 as shown in FIGS. 6 and 16. The reinforcement flexural module 320 is configured to resist a reactive force transmitted from the valve to the at least one flexural module 20 of the mechanism 10, in this example, the force flexural module 220. The reactive force is expected to have a component that is in an opposite direction of the parasitic deflection (dp) 471 of the alignment flexural module 420, and that acts on the force flexural module 220. The reinforcement flexural module 320 is thus configured to provide a countering force on the force flexural module 220 to prevent the force flexural module 220 from being undesirably displaced by the reactive force.

The reinforcement flexural module 320 preferably comprises at least one reinforcement component 340. A first end of the reinforcement component 340 is connected via a flexure 351 to a frame of the at least one flexural module 20, while a second end of the reinforcement component 340 is connected via flexures 352 to a support component 342. The support component 342 is configured to receive actuation by a reinforcement actuator 370.

In the embodiment of FIG. 6, the mechanism 10 comprises two flexural modules 20: a displacement flexural module 120 and a force flexural module 220. In this embodiment, the output portion 141-o of the displacement component 141 of the displacement flexural module 120 is connected to the frame 230 of the force flexural module 220 that is in turn connected to the output component 243 which displaces (in this configuration, in the direction shown by arrow 275) when the displacement actuator 170 and/or the force actuator 270 are actuated in the directions shown by arrows 171 and 271 respectively. When the output component 243 is displaced, reactive forces caused by the load are transmitted to the reinforcement components 340 in addition to the displacement flexural module 120 since the reinforcement module 320 is connected to the frame 230 of the force flexural module 220. By appropriate actuation of the reinforcement actuator 370, the reinforcement flexural module 320 is able to resist those reactive forces to prevent undesirable displacement of the force flexural module 220.

When used in an internal combustion engine for valve actuation, by connecting the output component 243 to the valve, the mechanism 10 shown in FIG. 6 can actuate valve operation with simultaneous mechanical displacement and force amplification or reduction, supported with reinforcement flexures inside a thermal shielded casing (if needed). The mechanism 10 is preferably controlled with the use of solid state actuators, and comprises two flexural modules, the displacement flexural module 120 and the force flexural 220 configured to actuate the mechanical displacement and force amplification or reduction respectively, while also having a reinforcement flexural module 320 to resist reactive forces from the valve. Depending upon the fuel supply pressure, an additional helical spring can be attached to the mechanism 10 as a counter force/load. Otherwise, the flexures 151, 152, 251, 252, 253, 351, 352 in the mechanism 10 bring the output component 243 (and thereby the valve) back to its original position.

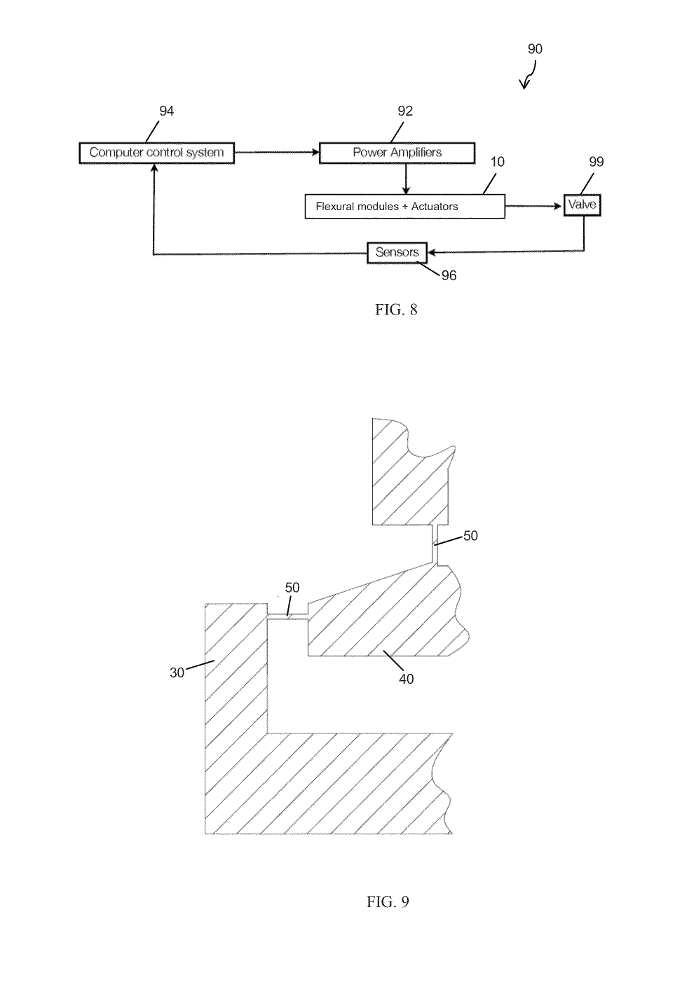

A system 90 for valve control as shown in FIG. 8 may thus comprise the mechanism 10 as shown in FIG. 6 configured to actuate a valve 99, with the actuators 170, 270, 370 connected to power amplifiers 92 controlled by a computer control system 94 that receives feedback provided by sensors 96 connected to the valve 99. The electronics 92, 94, 96 operate the different flexural modules 20 in the mechanism 10 independently and hence no two or more valve operations must be necessarily synchronized or linked as that of traditional cam systems. This provides the opportunity to adjust valve operation by appropriate programming and electronics 94, 96 without requiring any mechanical replacements.

In general, the power amplifiers 92 can amplify low voltage into high voltage signals. Each power amplifier 92 receives input signals from the digital signal controllers through a digital signal controller (DSC). A programmed DSC or control card is an intelligent part of the systems connected to the computer via communication ports. The positional information or feedback signals from the valve sensors are fed into the DSC via an analog-digital-converter (ADC). The realtime position of the valve is fed through the ADC to the DSC which processes and regulates valve displacement accordingly by sending signals to the power amplifiers 92.

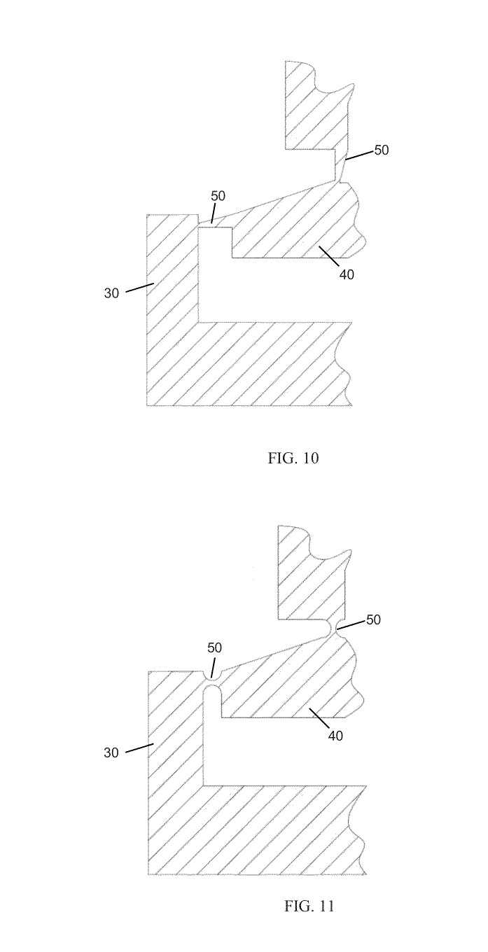

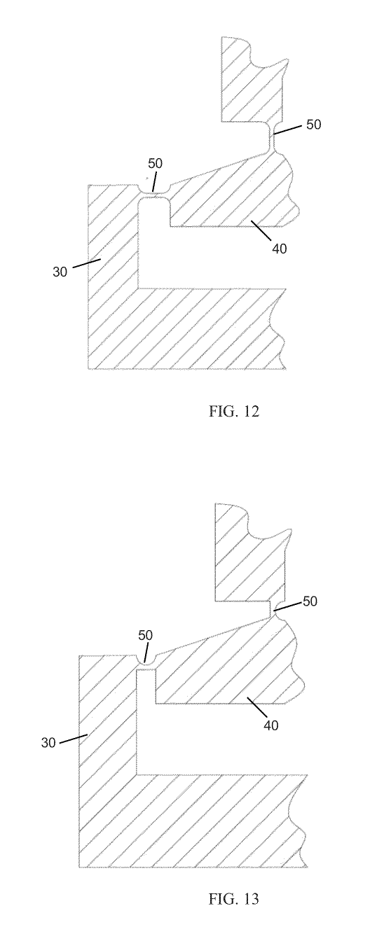

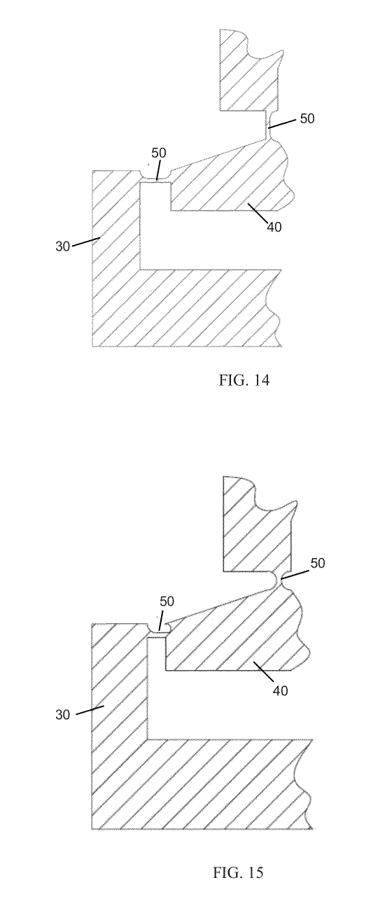

In all the embodiments described above, the flexures used may be of one or more various types such as a uniform cross-section leaf spring shown in FIG. 9, a non-uniform cross-section leaf spring shown in FIG. 10, a circular single axis flexure shown in FIG. 11, a non-circular single (i.e. elliptical) flexure shown in FIG. 12, a circular single notch flexure shown in FIG. 13, a non-circular single notch (i.e. elliptical) flexure shown in FIG. 14, an assymetrical flexure shown in FIG. 15, and any other appropriate configuration of flexure that may be envisaged.

The system 90 may be provided to replace conventional cam systems for internal combustion engines entirely with the flexural modules 20 performing required valve control operations. This eliminates the need for coupling with the engine through any transmission media and it functions independently of engine speed. The system 90 may be synchronized with the speed of the prime movers (engines), and yet function independently of the prime movers or other flexural modules. The system 90 may also be synchronized with other valve operations in real-time if this is required for optimization. Each flexural module 20 functions like a spring. Using electronics to control the configurations shown in FIGS. 6, 8 and 16, uniform speed, acceleration and/or variable acceleration (spike) may be achieved in valve actuation. The system 90 is preferably configured to be capable of achieving a setting time in micro seconds, while being capable of providing high frequency in terms of 1 KHz and above with high capacity solid state actuators for valve operations at extremely high speed.

A preferred manufacturing process of the mechanism 10 includes using wire-cut EDM (electrical discharge machining) to complete the mechanism 10 as a monolithic block of aluminum, where machining to form the frames 30 and components 40, 43 is performed using traditional milling and drilling processes while micro-machining using micro wire-cut EDM is used to form the small flexures 50. Where the mechanism 10 is formed for use in an internal combustion engine, the entire mechanism may have a size of about 75 mm×75 mm×50 mm. A thick block of metal may be used to fabricate multiple mechanisms and then the machined block can be cross sectioned into individual mechanisms, again using wire-cut EDM. The material and/or thickness of each mechanism 10 can be chosen to provide a desired stiffness and/or spring constant. The stiffness of the mechanism 10 can vary from as low as 10 Kg/mm to 10,000 Kg/mm. Materials used for the mechanism 10 can include spring steel, aluminum, phosphor bronze, invar, elinvar, copper, silicon (111), bronze, magnesium, molybdenum, titanium, tungsten, cast iron, mild steel, hard steel, 18/8 SS, duralumin, diamond, silicon carbide, silicon nitride, alumina, zirconia, tungsten carbide, fused silica, fused quartz, zerodur, granitan, crown glass. Besides wire-cut EDM, other methods such as three-dimensional printing may be used to fabricate the mechanism 10.

Using the mechanism 10 in an internal combustion engine has the advantages of optimizing circulation of fuel gas at intake and exhaust, to deploy operating modes for optimized fuel consumption, clean exhaust technology and performance. The frequency or periods of valve lift in the traditional engines are conditioned by the geometrical profile of the cams, which is fixed no matter how the engine is operating. The electronically controlled flexural module system 90 is however able to optimize the various phases of engine running During idling phases, controlled valve opening admits the necessary quantity of air. The timing of valve control achievable with the system 90 to open a single intake valve makes it possible to stabilize the engine at idling point, which consumes little fuel while ensuring a good level of drivability. This may allow elimination of existing exhaust gas recirculation circuits, and may reduce fuel consumption and polluting exhaust emissions, in particular, nitrogen oxides, produced by the engine.

Whilst there has been described in the foregoing description exemplary embodiments, it will be understood by those skilled in the technology concerned that many variations in details of design, construction and/or operation may be made without departing from the claims.

1. A mechanism for effecting a displacement output, the mechanism comprising:
at least one flexural module, the at least one flexural module comprising:
a frame;
at least one component connected to the frame via a first flexure and connected to the displacement output via at least a second flexure;
wherein the at least one flexural module is monolithic and/or unitary and each component is configured to be independently actuatable such that the displacement output is displaced when at least one component is actuated.

2. The mechanism of claim 1, wherein the at least one component is configured to receive actuation from an actuator.

3. The mechanism of claim 1, wherein the at least one component comprises a displacement component configured to amplify displacement provided by a displacement actuator.

4. The mechanism of claim 3, wherein the displacement component comprises a bearing portion connected to the frame via the first flexure, an input portion configured to receive actuation by the displacement actuator, and an output portion configured to be connected via the at least a second flexure, wherein distance between the output portion and the bearing portion is greater than the distance between the input portion and the bearing portion.

5. The mechanism of claim 4, wherein the output portion of the displacement component is configured to be connected to a second component.

6. The mechanism of claim 4, wherein the displacement component comprises a second output portion configured to be connected to a second output component, the output portion being provided on one side of the bearing portion and the second output portion being provided on another side of the bearing portion.

7. The mechanism of claim 1, wherein the at least one component comprises a force component configured to amplify force provided by a force actuator.

8. The mechanism of claim 7, wherein the force component has a bearing portion connected to the frame via a flexure, an input portion configured to receive actuation by the force actuator, and an output portion configured to be connected via the at least a second flexure, wherein distance between the input portion and the bearing portion is greater than the distance between the output portion and the bearing portion.

9. The mechanism of claim 1, wherein the at least one component comprises a reinforcement component configured to resist a reactive force transmitted from an output component to the at least one flexural module.

10. The mechanism of claim 9, wherein the reinforcement component comprises a first end of the at least one reinforcement component connected via flexures to a frame of the at least one flexural module, a second end of the at least one reinforcement component connected via flexures to a support component, the support component configured to receive actuation by a reinforcement actuator.

11. The mechanism of claim 1, wherein the at least one component comprises an alignment component, the alignment component configured to connect the frame and a further component via flexures such that actuation of the further component results in translational and/or non-rotational movement of the further component.

12. The mechanism of claim 11, wherein the alignment module comprises two alignment components having a same length and arranged in parallel, first ends of the two alignment components connected via flexures to the frame and second ends of the two alignment components connected via flexures to the further component.

13. The mechanism of claim 1, wherein the flexures are selected from the group consisting of uniform cross section leaf spring type, non-uniform cross section leaf spring type, circular single axis, non-circular single axis, circular single notch non-circular single notch, assymetrical and any combination thereof.

14. The mechanism of claim 3, wherein the displacement component, the reinforcement component and the alignment component are all connected between the frame and the force component, and the force component is connected to the displacement output.

15. A system for controlling a valve comprising:
at least one actuator;
a valve having a control stem;
an integral and or unitary flexural module configured to receive actuation from the actuator and to correspondingly actuate the control stem;
a controller configured to energise the actuator according to predetermined instructions such that actuation of the at least one flexural module results in a predetermined displacement of the valve.

16. The system of claim 15, further comprising at least one sensor configured to provide a control signal to the controller.

17. The system of claim 16 wherein the valve controls a fuel flow, an intake flow or an exhaust flow in an internal combustion engine, and wherein the sensor relates to the position of a piston and/or a shaft.
